(19) United States
(12) Patent Application Publication
(10) Pub. No.: US 2024/0028819 A1
(43) Pub. Date: Jan. 25, 2024

(54) METHOD AND AUTOMATIC SYSTEM FOR THE PRODUCTION OF ELECTRONIC DOCUMENTS, IN PARTICULAR DIGITAL REPORTS

(71) Applicant: ELETTRONICA MARITTIMA S.R.L., Mesola (IT)

(72) Inventors: Enrico Ghezzo, Mesola (IT); Sergio Cicalo', Mesola (IT)

(21) Appl. No.: 18/257,445

(22) PCT Filed: Dec. 15, 2021
(86) PCT No.: PCT/IB21/61768

§ 371 Date: Jun. 14, 2023

(30) Foreign Application Priority Data
Dec. 15, 2020 (IT) 102020000030845

(51) Int. Cl. G06F 40/174; G06K 7/10; G06V 30/10; G06V 30/41; G06F 40/197

(52) U.S. Cl. CPC G06F 40/174; G06K 7/10297; G06V 30/10; G06V 30/41; G06F 40/197

(57) ABSTRACT

A system for automatically filling in identification data in an electronic document, in particular a digital report, includes a computer or electronic device with associated data viewing and reading systems, in particular a sensor designed to capture high-resolution images and an NFC short-range wireless connectivity apparatus; the computer or electronic device being designed to run a computer program with which the data viewing and reading systems interact with an electronic identification document, in particular an identity card or passport, in order to acquire the data contained therein.

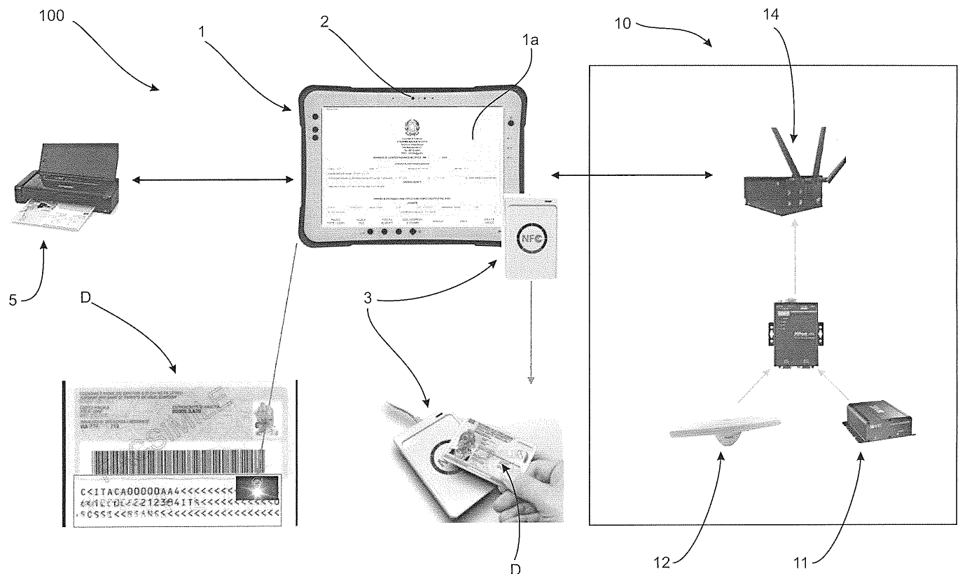

### TECHNICAL FIELD

The present invention relates, in general, to a system for the acquisition of information contained in identification documents such as electronic identity cards and passports, and to automatic entering the acquired data into electronic documents.

In greater detail, the invention relates to a system for automatically filling in acquired identification data into electronic documents. The acquired data, in any case, may also be stored in further electronic documents or files connected thereto, that is stored for later use and digitally transmitted to a remote server.

### Technical Problem

The invention meets the dual need of police forces, Coast Guard or Financial Police or other military personnel in the same situation, to speed up inspection operations as much as possible. Although the invention can be advantageously used in any field (terrestrial, nautical or air), in which the simplification of reporting procedures and the optimization of execution times are of particular importance, it is particularly important in the nautical field, as a tool to be used during inspections of private or commercial vessels. In these cases, in fact, reducing downtimes of vessels, especially in rough sea and/or when the object of inspection is a great tonnage merchant vessel, is an absolute priority.

In fact, it must be considered that, especially for commercial vessels, even one hour downtime can cost a lot in economic terms, in addition to the fact that keeping two vessels one beside another can be dangerous, especially for the smaller one, with the risk of major damage.

For these reasons, the invention applied in the nautical field will be described by way of a not restrictive example.

Therefore, on the whole, the invention allows a rapid acquisition of the data necessary for filling in the electronic document, as well as its printing, digitalization and recording of said signed document, i.e. report, with storage in a local relational database and subsequent transmission to a remote database.

In order to be implemented, the system proposed by the invention includes the use of a series of latest generation technologies for the automatic acquisition of the identification data necessary for filling in the document; since the invention is related with and supporting the police, control and inspection forces, said identification data can be related, by way of a not exhaustive example, for example to a person, vessel, position of the military unit, name of the reporting officer, date and time, which allows to simplify and speed up the drafting of the report.

As already said, the invention is also designed to allow a possible storage and association of the data of the reports considered of interest, with the possibility of populating and querying a national database of the reports.

### Advantages

Among many others, the following advantages are to be pointed out:
Automatic acquisition of all personal identification data by means of electronic ID card or passport;
Front/back scanning of the paper identity document;
Selection of the type of report from a set of pre-formatted templates, if present;
Automatic heading and numbering of the report;
Automatic populating of the date and time of the report beginning, carried out by reading the data of the computer in use or, preferably, of a geolocation system (GPS or others), for example of the inspected vessel;
Automatic populating of a field relating to the position of the vessel at the time of inspection, by taking longitude and latitude data from the same geolocation system;
Automatic identification of the vessel or in general, the vehicle;
Automatic populating, by reporting officer, who draws data from a previously stored local database;
Automatic populating of position data (via GPS of the electronic device on which the program is run);
Possible automatic populating of the identification data of the inspected vehicle (for example, vessel), if equipped with an AIS (Automatic Identification System) transponder, it is possible to take them from the AIS list after interfacing with the Navigation System (SdN);
Printing of the report transmitting data via Wi-Fi with a portable Wi-Fi printer;
Scanning of the signed report via camera as an automatic attachment;
Querying with filters and viewing of reports, people and officers from local databases.

### SUMMARY OF THE INVENTION

The foregoing purposes and advantages are achieved by means of a system for automatically filling in an electronic document with identification data, in particular a digital report, which comprises a computer or electronic device with data viewing and reading systems, in particular a sensor designed to capture high-resolution images and an NFC short-range wireless connectivity apparatus; said computer or electronic device being designed to run a computer program with which said data viewing and reading systems interact with an electronic identification document,

in particular, the document may be an identity card or passport, in order to acquire the data contained therein.

### BRIEF DESCRIPTION OF THE DRAWINGS

The characteristics of the invention under discussion will be evident from the following description of the preferred embodiments in accordance with what is proposed in the claims and with the help of the enclosed FIGURE, in which the sole FIGURE illustrates a possible example of the invention, in particular the architecture of the system with its essential and optional components.

### DETAILED DESCRIPTION

According to the sole FIGURE, the system for automatically filling in a digital report according to the invention is suitable for operating during an inspection carried out on a vehicle, such as a private or commercial vessel. The system is intended to fill in, at least partially in an automatic way, a plurality of data fields in a basic data structure, residing in the digital memory of a general purpose computer 1 or other dedicated electronic device, and corresponding to a standardized, pre-formatted and unfilled version of said digital report, intended to be completed with data relating to a person responsible for the above-mentioned vessel or other vehicle and/or the vessel.

In particular, the system comprises, preferably but not exclusively, the above-mentioned processor 1, such as a tablet with high specifications; said tablet integrates a sensor 2 aimed at acquiring high-resolution images, in this case a camera such as a video camera, and an NFC reader (3) that allows the automatic scanning of the data of an electronic identification document D, such as the electronic identity card (CIE) or passport of a person responsible for the vehicle.

In greater detail:
the video camera 2 acquires the image of the document framed by the operator in real time, and identifies and detects the MRZ (Machine Readable Zone) code of the document by means of a software for image processing and character recognition, even if the document in the image is blurred, rotated, tilted or of small size, importing all the data available in that code;
subsequently, bringing the CIE D closer to the NFC reader 3, the system detects and imports further identification data of the person, and enters them in appropriate fields in the report.

In accordance with a preferred embodiment of the invention, the system can also import the GPS data of the tablet 1 for automatic filling in the temporal reference (exact date and time) and position field.

In accordance with a further aspect of the invention, when interfaced with the navy vessel Navigation System, the system imports AIS data:
of the contested/verified vessel;
the GPS and time reference data of the vessel if considered more reliable.

Moreover, after the report has been automatically filled in and printed on paper, the system allows scanning the signed report by means of the above mentioned video camera 2, or other video camera or still camera, and attaching photos as further evidence of a detected infringement.

Generalizing the example shown in the FIGURE, it is possible to say that the invention relates to a system for automatic filling in an electronic document, in particular a digital report, with data, the system comprising a computer or electronic device 1 with data viewing and reading systems, in particular a sensor 2 designed to capture high-resolution images and a NFC short-range wireless connectivity apparatus 3, and where the computer or electronic device 1 is designed to run a computer program with which said data viewing 2 and reading systems 3 interact with an electronic identification document D, in particular identity card or passport, in order to acquire the data contained therein.

According to an aspect of the invention, the computer or electronic device further includes a GPS module and/or a WiFi module so as to be associated with an AIS automatic identification system 10 and/or GPS data 12.

The processor or electronic device 1 is advantageously connected to the automatic identification 11 system 10 and/or GPS data 12 by means of a wireless communication line (typically a Wi-Fi connection), by means of an on-board router 14 present onboard the vessel.

Again, the computer or electronic device 1 is associated with at least one screen 2 for graphically reproducing the electronic document to be automatically filled in.

The compilation system of the invention further comprises a management program, operating in the aforementioned computer or electronic device 1, provided with suitable software procedures intended to perform the above described operations.

In particular, and in a not restrictive way, the following procedures are provided: a software procedure for personal identification, aimed at detecting the identification data of the person responsible for the aforesaid electronic identification document; a software procedure for identification of the means of transport aimed at detecting the identification data of the aforesaid vessel, a populating software procedure, aimed at acquiring data generated by the aforesaid procedures of person identification and identification of the means of transport and inserting them in appropriate positions in the data structure relating to the digital report being filled in; a software procedure for displaying the digital report being filled in, and the data fields that are progressively populated with the acquired information.

The structure and the formulation of the above mentioned procedures will not be described here in further detail since they are drafted using standard programming languages, and thus they are to be considered within the reach of the technician of average experience.

Peripherals such as printers 5 can be associated by respective communication ports or by WiFi communication protocol or other, in order to allow the immediate printing of the document on paper, the document being automatically filled in according to the teaching indicated herein, subsequent signing and scanning, likewise by the camera combined with the electronic device and dedicated software procedure for the automatic detection of the document.

In addition, the invention relates also to the method for automatic filling in an electronic document (report), the method comprising at least the steps of:
a. acquiring a first set of said data by reading, through optical recognition, the characters printed in an electronic identification document, in particular an identity card or passport,
b. storage of said first set of data,
c. acquiring a second set of said data contained in said electronic identification document and through NFC communication interface 3,
d. storage of said second set of data,
e. filling in respective text fields of an electronic document using said first and second sets of data;
f. acquiring a third set of data relating to the identification of the above mentioned vessel or another vehicle;
g. storage of said third set of data;
h. populating a basic data structure, residing in the digital memory of the computer or electronic device 1 and corresponding to a standardized, pre-formatted and unfilled version of said digital report, with the above mentioned first, second and third data sets.

According to an advantageous aspect of the invention, the step of acquiring the second data set uses the first data set as an access key to the data contained in the microprocessor of the electronic identity card or electronic passport and comprises acquiring the personal data and digital image stored therein.

According to another aspect of the invention, the first acquired set of data corresponds to the MRZ code of the electronic identification document.

Preferably, the data of the first and/or second sets of data are stored in an associated database.

It is also an object of the invention to provide a computer program configured to interact with one or more of the aforementioned systems for viewing and/or capturing and/or reading the data of the electronic identification document D, identity card or passport.

In particular, said computer program comprises portions of code for performing the method of automatically filling in electronic documents as described above and when said computer program is executed on said computer or electronic device 1.

As already said, the program uses a graphical interface configured to display, on the screen, the structure of the corresponding document to be filled in, while at the same time showing the fields or areas with the previously acquired data. The operator is also allowed to fill in/incorporate further fields typing them manually.

The system of reporting and automatic acquisition of the data of the person proposed by the invention allows to automate, digitize, simplify and speed up the processes of identification of the person and reporting by the administration. Furthermore, said system and method allow also to:
digitize nationwide all reports for quick filling in, storing and consultation,
verify instantly if a person has been previously contested and/or verified,
uniform reporting processes,
facilitating operatives in rapid reporting and identification.

It is understood that what is described above has only an illustrative and not limiting value, therefore any detail variations that may be necessary for technical and/or functional reasons are considered from now on within the same protection scope defined by the claims below.

1. A system for automatically filling in identification data in a digital report, to be filled in during an inspection carried out on a means of transport, including a vessel or another vehicle, said system comprising: a computer or electronic device with associated thereto data viewing and reading systems, in particular a sensor designed to capture high-resolution images and an short-range wireless connectivity apparatus; said computer or electronic device configured to run a computer program with which said data viewing and reading systems interact with an electronic identification document, in particular an identity card or passport, in order to capture data contained therein, and also interact with a corresponding identification system of said means of transport in order to capture data thereof; a basic data structure, that resides in a digital memory of said computer and corresponds to a standardized, pre-formatted and unfilled version of said digital report, configured for filling in with data relating to a person responsible for said means for transport; a software procedure for personal identification, configured for operation in said computer or electronic device to detect identification data of a responsible person from said electronic identification document; a software procedure for identification of the means of transport, configured for operation in said computer or electronic device to detect identification data of said means of transport; a populating software procedure, configured for operation in said computer or electronic device to collect data generated by said procedures for identification of the responsible person and identification of the means of transport for insertion in respective positions in said digital report.

2. The system according to claim 1, wherein said means of transport includes an automatic identification system, and wherein said identification procedure of the means of transport is an automatic identification system data interfacing and acquisition procedure.

3. The system according to claim 1, wherein the computer or electronic device further includes a global positioning system module and/or a WiFi module for association automatic identification system data and/or global positioning system data, via a router residing in the means of transport.

4. The system according to claim 1, wherein the computer or electronic device comprises at least one display for graphically presenting the digital report as available for automatic fill-in.

5. A method for automatically filling in a digital report during an inspection carried out on a means of transport, including a vessel or another vehicle, the method comprising:
a. acquiring a first set of data by reading, through optical recognition, characters printed in an electronic identification document, in particular an identity card or a passport,
b. storing said first set of data,
c. acquiring a second set of data contained in said electronic identification document via a near field communication interface,
d. storing said second set of data,
e. filling respective text fields of said digital report using said first set of data and said second set of data;
f. acquiring a third set of data relating to identification of said means of transport;
g. storing said third set of data;
populating a basic data structure, that resides in a nonvolatile storage medium of a computer or electronic device and corresponds to a standardized, pre-formatted and unfilled version of said digital report, with said first set of data, said second set of data, and said third set of data.

6. The according to claim 5, wherein the acquiring the second set of data uses the first set of data as an access key to the data contained in a microprocessor of the electronic identity card or passport and comprises acquiring personal data and a digital image stored therein.

7. The method according to claim 5, wherein said first set of data corresponds to a machine readable zone of the electronic identification document.

8. The method according to claim 5, wherein said first set of data and/or said second set of data are stored in an associated database.

9. The method according to claim 5, wherein said third set of data is acquired by a software procedure for vehicle identification operating in said computer or electronic device, from data present in a digital identification system of said means of transport, by means of a connection on a standard digital communication line.

10. A computer program configured to interact with one or more systems for viewing and/or capturing and/or reading data contained in an electronic identification document, in particular an identity card or passport, wherein said computer program comprises portions of code for performing the method of automatically filling in digital reports, according claim 5, when said computer program is stored in a non-volatile memory device of said computer or electronic device and executed on said computer or electronic device, and wherein said computer or electronic device further comprises a graphical interface configured to display the digital report with a layout for presenting respective fields or areas with the first set of data, the second set of data, and the third set of data.
